(19) United States
(12) Patent Application Publication
(10) Pub. No.: US 2014/0300456 A1
(43) Pub. Date: Oct. 9, 2014

(54) Bicycle Alarm with Signaling Siren and Light

(71) Applicant: Nathan Parks, Livemore, CA (US)

(72) Inventor: Nathan Parks, Livemore, CA (US)

(21) Appl. No.: 13/855,716

(22) Filed: Apr. 3, 2013

(51) Int. Cl. B62J 3/00

(52) U.S. Cl. CPC B62J 3/00
USPC 340/432

(57) ABSTRACT

A signaling and alarm device that is attachable, without using tools, to a bicycle or other conveyance using a flexible fixture and S-hook fastener. By way of two slide switches and one push-button switch located on the device housing, the device is able to achieve an alarm mode, an audible signaling mode, and a visual signaling mode. When in alarm mode, an alarm is activated by vibration. Waterproof housing encloses a battery compartment, electronic circuit board, and piezo siren.

### CROSS-REFERENCE TO RELATED APPLICATIONS

U.S. Pat. No. 3,828,310 to Miller discloses a bicycle theft alarm.

U.S. Pat. No. 3,941,081 to Nakamura discloses an alarm for a bicycle.

U.S. Pat. No. 5,262,757 to Hansen discloses an electronic signaling device for bicycles and the like.

U.S. Pat. No. 5,270,681 to Jack discloses a bicycle and bicycle elements theft alarm apparatus.

U.S. Pat. No. 3,721,956 to Hamman and Dawson discloses a bicycle theft alarm operable by vibration.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

Signaling devices are widely used by bicyclists. Signaling devices vary in function, size, features, and material. Signaling devices are commonly used by bicyclists to alert persons nearby that the user is approaching, or, that there is a hazard in the area.

Formerly, signaling devices have been designed so that they are not easily removed or attached to the conveyance. Additionally, signaling devices have been made with limited features. A particular device may act as a light, a separate device as a theft deterring alarm, and yet another as a notification siren.

Submitted in this utility patent application is a device that uses an electronic vibration detection alarm for a bicycle or any conveyance that a user desires to attach to said device. Said device includes an enclosed circuit board with an embedded vibration switch. The vibration switch is adapted to send a signal to a piezo siren upon the receipt of a vibration through the device's connection to the bicycle. Provided is a piezo siren coupled to said enclosed circuit board.

The use of bicycle alarm mechanisms is known in the prior art. More specifically, bicycle alarm mechanisms heretofore devised and utilized for the purpose of preventing unauthorized access of a bicycle are known to consist basically of familiar, expected and obvious structural configurations, notwithstanding the myriad of designs encompassed by the crowded prior art which have been developed for the fulfillment of many objectives and requirements.

By way of example, U.S. Pat. Des. 255,882 to Kim discloses an alarm and page signal transmitter. U.S. Pat. No. 3,828,310 to Miller discloses a bicycle theft alarm. U.S. Pat. No. 3,941,081 to Nakamura discloses an alarm for a bicycle. U.S. Pat. No. 5,262,757 to Hansen discloses an electronic signaling device for bicycles and the like. U.S. Pat. No. 5,270,681 to Jack discloses a bicycle and bicycle elements theft alarm apparatus. U.S. Pat. No. 3,721,956 to Hamman and Dawson discloses a bicycle theft alarm operable by vibration.

### BRIEF SUMMARY OF THE INVENTION

This invention relates to the manufacture of a unique signaling device, easily attached and removed from a conveyance (i.e. bicycle). The present invention relates particularly to a battery powered electronic device that uses a piezo siren and lights for notification. The user is able to select signal mode, alarm mode, and visual notification mode using switches located on the device housing. Said device has the unique feature of a vibration activated alarm which is active only in alarm mode.

### BRIEF DESCRIPTION OF THE SEVERAL VIEWS OR THE DRAWING

FIG. 1A Right Side/front view of device

FIG. 1B Right Side/back view of device

FIG. 1C Right Side view of device

FIG. 1D Top view of device

FIG. 1E Left Side view of device

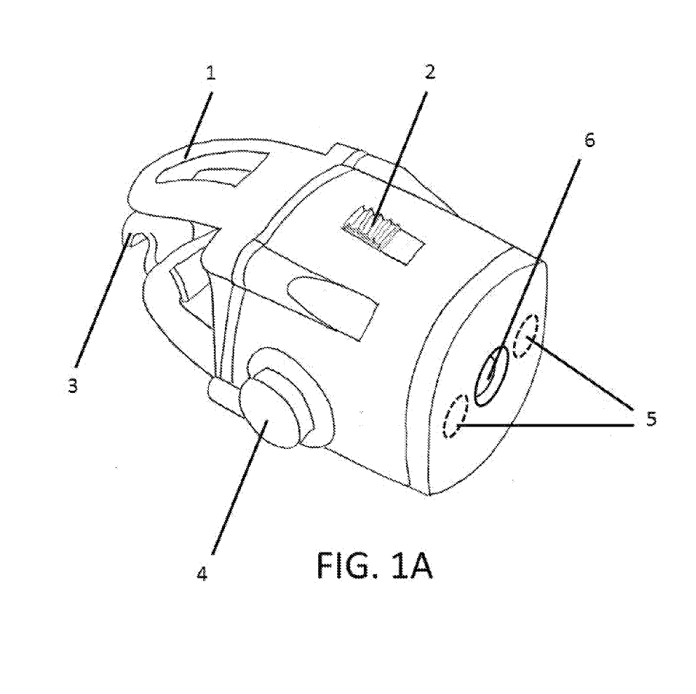

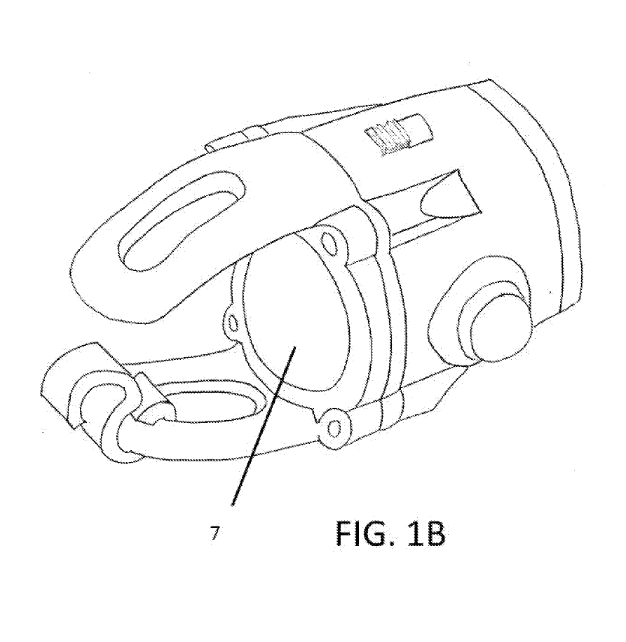

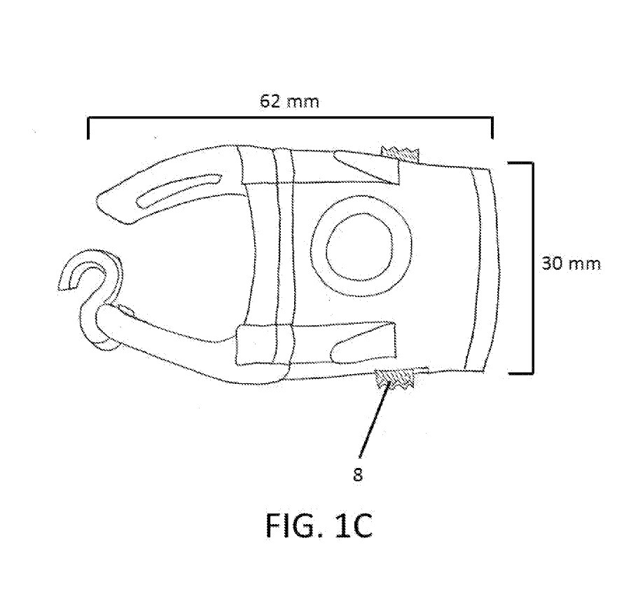

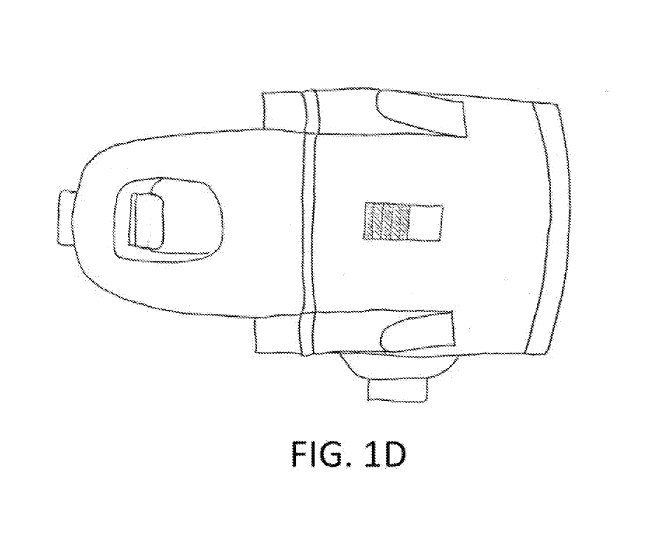

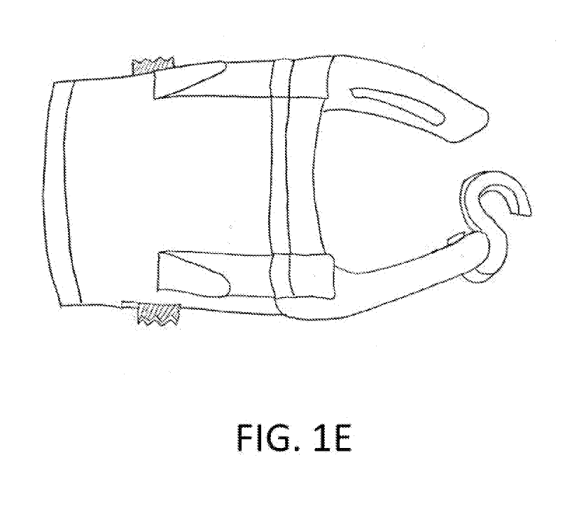

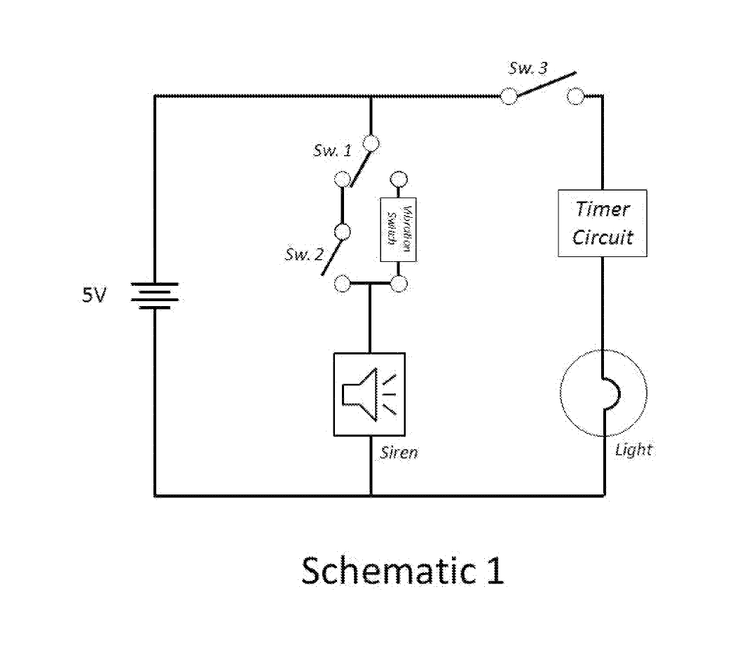

Schematic 1 Electronic diagram of Device Function

1 Flexible mounting fixture so that the device is easily attached to and removed from bicycle or other conveyance.

2 Switch to activate lights on front of device to flash (Switch 3 in wiring diagram).

3 S-hook used as fastener between two halves of flexible mounting fixture.

4 Push-button switch to activate piezo alarm siren (Switch 2 in wiring diagram).

5 Notification lights.

6 Piezo siren aperture that encloses piezo siren.

7 Removable battery compartment housing.

8 Switch to activate and deactivate device alarm mode feature (Switch 1 in wiring diagram).

### DETAILED DESCRIPTION OF THE INVENTION

Said battery powered electronic device will allow the user to activate a siren (6) using push-button switch (4) that will allow for notification when a hazard is present. Said device will also act as an alarm. The alarm mode is entered using a switch (8) on the device housing. When said switch (8) is in alarm mode, vibration will cause device to activate alarm siren (6). Said device will also act as visual notification. Visual notification mode is activated using a switch (2) on the device housing. When the switch (2) is in visual notification mode, two lights (5) on the front of the device flash on and off repeatedly until switch (2) is moved to the disabled position. The device is attached to the bicycle or other conveyance using a flexible mounting fixture (1) that is secured with an S-hook fastener (3). The device battery cavity is accessible by a removable backing (7).

While prior art fulfill their respective, particular objective and requirements, the aforementioned patents do not describe a bicycle alarm/signaling/light system that detects unauthorized attempts to access a bicycle and thereby transmits an alarm signal in the immediate vicinity and further allows for the device to be used as an audible signaling system during a use event hazard encounter and a visual signaling system.

In this respect, the present invention substantially departs from the conventional concepts and designs of the prior art, and in doing so provides an apparatus developed for the purpose of preventing unauthorized access of a user's bicycle; the ability to issue audible alarm signals during a hazard event; and provide increased user visibility with an onboard, switch-activated forward mounted light system.

Therefore, it can be appreciated that there exists a continuing need for new and improved bicycle alarm/signaling/light systems which can be used for preventing unauthorized access of a user's bicycle, publishing hazards, and increasing user visibility. In this regard, the present invention substantially fulfills this need.

The inventor claims:

1. A weatherproof chassis attachable to a bicycle or other apparatus. Comprising of:
a. A battery means for powering said circuit accessed by a removable lid on the back of said device housing.
b. A user operated electrical switch located on said device housing connected to said battery for enabling and disabling the alarm circuit.
c. A vibration sensor capable of changing an alarm siren from a passive to an active state upon detection of vibration.
d. A user operated push-button switch located on said device housing that allows the user to activate an alarm siren, powered by said battery, upon the detection of a hazard during a use event.
e. A user operated electrical switch located on said device housing that activates forward mounted lights to flash repeatedly until said switch is moved to the disabled position.
f. A flexible fixture and S-hook fastener that allows the device to be easily installed and removed from a bicycle or other conveyance.
